(19) United States
(12) Patent Application Publication
(10) Pub. No.: US 2008/0037959 A1
(43) Pub. Date: Feb. 14, 2008

(54) INFORMATION PROCESSING APPARATUS AND PLAYING METHOD

(75) Inventor: Ryo Hatano, Kodaira-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/836,113

(22) Filed: Aug. 8, 2007

(30) Foreign Application Priority Data
Aug. 8, 2006 (JP) 2006-216125

(51) Int. Cl. H04N 5/00

(52) U.S. Cl. 386/126; 386/125; 386/E05.064

(57) ABSTRACT

According to one embodiment, an information processing apparatus includes an optical disc apparatus which reproduces data from an optical disc with one of first type content and second type content recorded thereon, a first content playback unit which plays the first type content, a second content playback unit which reads a playlist indicating a procedure of playback the second type content, and playing the second type content, and judgment/playback unit which determines whether the optical disc stores a file unique to the second type content, causing the first content playback unit to play the first content when it is determined that the file is not stored, and causing the second content playback unit to play the second content when it is determined that the file is stored.

### CROSS-REFERENCE TO RELATED APPLICATIONS

This application is based upon and claims the benefit of priority from Japanese Patent Application No. 2006-216125, filed Aug. 8, 2006, the entire contents of which are incorporated herein by reference.

### BACKGROUND

1. Field

One embodiment of the invention relates to an information processing apparatus and playing method for playing advanced content and standard content of an HD DVD.

2. Description of the Related Art

In recent years, digital versatile discs (DVDs) and their replay apparatuses have been spread, and high definition (density) DVDs capable of high density recording and high quality recording have come to be available.

HD DVD drives installed in, for example, PCs support not only HD DVDs but also CDs or DVDs.

HD DVD content can be classified into standard content (category 1) and advanced content (categories 2 and 3).

To playback advanced content, players such as optical disc devices must read a playlist, written in XML, which is not contained in standard content.

Therefore, when an HD DVD is inserted in an optical disc device, it is necessary for the optical disc device to determine the type of content stored on the HD DVD.

Jpn. Pat. Appln. KOKAI Publication No. 2001-57057 discloses a technique of determining the type of content stored on a DVD (which is based on DVD-Audio standard and DVD-Video standard), from the management information of the DVD, and then playing the content. However, the process of determining the type (i.e., category) of content stored on a disc, using management information, is very complex.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating a notebook personal computer as an information processing apparatus according to an embodiment of the invention;

FIG. 2 is an exemplary block diagram illustrating the configuration of the personal computer of FIG. 1;

FIG. 3A and FIG. 3B are exemplary views useful in explaining the structures of standard content and advanced content, respectively;

FIG. 4A, FIG. 4B and FIG. 4C are views useful in explaining discs of categories 1, 2 and 3, respectively;

FIG. 5 is an exemplary view illustrating a volume space example in a disc according to the invention;

FIG. 6 is an exemplary view useful in explaining directory examples and file examples defined for a disc;

FIG. 7 is an exemplary view illustrating the configuration of player software;

FIG. 8 is an exemplary block diagram illustrating the configuration of a filter graph for playing advanced content;

FIG. 9 is an exemplary block diagram illustrating the configuration of a filter graph for playing standard content;

FIG. 10 is an exemplary block diagram illustrating the configuration of a filter graph for replaying a DVD; and

FIG. 11 is a flowchart illustrating the procedure of playback processing by player software.

### DETAILED DESCRIPTION

Various embodiments according to the invention will be described hereinafter with reference to the accompanying drawings. In general, according to one embodiment of the invention, an information processing apparatus comprises an optical disc apparatus which reproduces data from an optical disc with one of first type content and second type content recorded thereon, a first content playback unit which plays the first type content, a second content playback unit which reads a playlist indicating a procedure of playback the second type content, and playing the second type content, and judgment/playback unit which determines whether the optical disc stores a file unique to the second type content, causing the first content playback unit to play the first content when it is determined that the file is not stored, and causing the second content playback unit to play the second content when it is determined that the file is stored.

An Embodiment of the invention will be described with reference to the accompanying drawings.

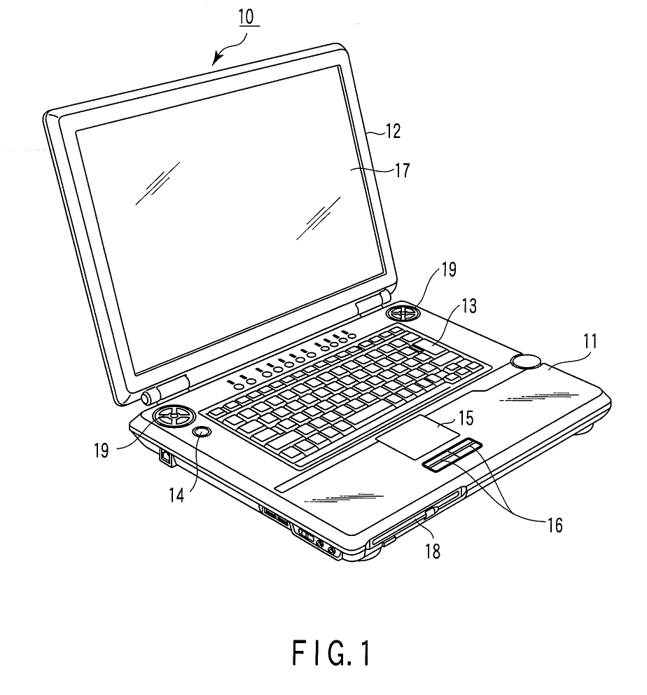

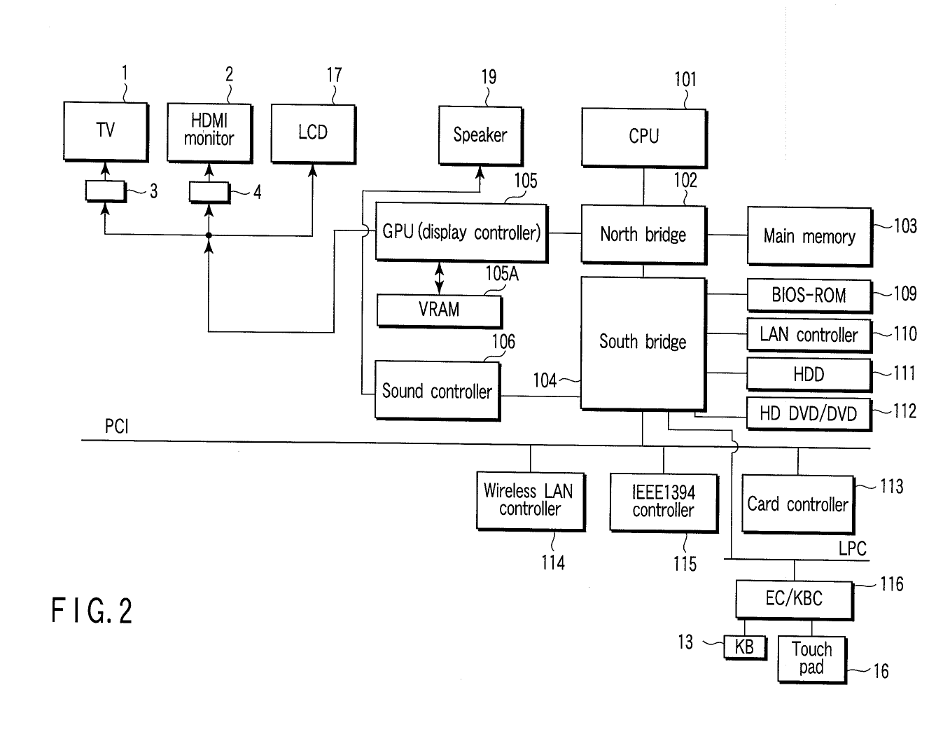

Referring first to FIGS. 1 and 2, a description will be given of an information processing apparatus according to the embodiment of the invention. The information processing apparatus is, for example, a notebook personal computer 10.

FIG. 1 is a perspective view showing a state in which the display unit of the notebook personal computer 10 is open. The computer 10 comprises a PC proper 11 and display unit 12. The display unit 12 incorporates a thin film transistor liquid crystal display (TFT-LCD) 17, and the display screen of the LCD 17 is located at substantially the center of the display unit 12.

The display unit 12 is attached to the PC proper 11 so that it can pivot between its open and closed positions. The PC proper 11 has a case shaped like a thin box. On the upper surface of the case, there are provided a keyboard 13, power button 14 for power on/off of the computer 10, touch pad 15, touch pad control button 16, speaker 19, etc.

Referring then to FIG. 2, the system configuration of the computer 10 will be described.

As shown in FIG. 2, the computer 10 comprises a CPU 101, north bridge 102, main memory 103, south bridge 104, graphics processing unit (GPU) 105, video memory (VRAM) 105A, sound controller 106, BIOS-ROM 109, LAN controller 110, hard disc drive (HDD) 111, high definition digital versatile disc (HD DVD)/DVD drive (ODD) 112, card controller 113, wireless LAN controller 114, IEEE 1394 controller 115, embedded controller/keyboard controller IC (EC/KBC) 116, digital TV tuner 117, etc.

The CPU 101 is a processor for controlling the operation of the computer 10, and executes an operating system and various application programs loaded from the hard disc drive (HDD) 111 to the main memory 103. The CPU 101 also executes a basic input output system (BIOS) stored in the BIOS-ROM 109. The BIOS is a program for hardware control.

The north bridge 102 is a bride device that connects the local bus of the CPU 101 to the south bridge 104. The north bridge 102 contains a memory controller for controlling access to the main memory 103. The north bridge 102 also has a function of accessing the GPU 105 via a PCI EXPRESS serial bus of.

The GPU 105 is a display controller that controls the LCD 17 used as the display monitor of the computer 10. Display signals generated by the GPU 105 are sent to the LCD 17. The display signals can also be sent to an external TV1 and HDMI monitor via interfaces 3 and 4, respectively, incorporated in the PC proper 11.

The south bridge 104 controls devices connected to a low-pin-count (LPC) bus, and devices connected to a peripheral-component-interconnect (PCI) bus. The south bridge 104 contains an integrated-drive-electronics (IDE) controller for controlling the HDD 111 and ODD 112. The south bridge 104 also has a function of accessing the sound controller 106.

The sound controller 106 is a sound source device, and outputs to-be-play audio data to the speaker 19.

The card controller 113 controls cards such as a PC card and secure digital (SD) card. The wireless LAN controller 114 is a wireless communication device for performing wireless communication based on, for example, the IEEE 802.11 standard. The IEEE 1394 controller 115 accesses external devices via an IEEE 1394 serial bus. The embedded controller/keyboard controller IC (EC/KBC) 116 is a one-chip microcomputer formed of an embedded controller for power management, and a keyboard controller for controlling the keyboard (KB) 13 and touch pad 15. The embedded controller/keyboard controller IC (EC/KBC) 116 also has a function of powering on/off the computer 10 in accordance with the operation of the power button 14 by a user.

The content recorded on an HD DVD inserted in the ODD 112 includes a plurality of types of content. The types of the content recorded on the HD DVD will now be described.

In this description, two types of content are defined, i.e., standard content and advanced content. The standard content is formed of navigation data and a video object on a disc, and is obtained by extending the version 1.1 DVD-video standard.

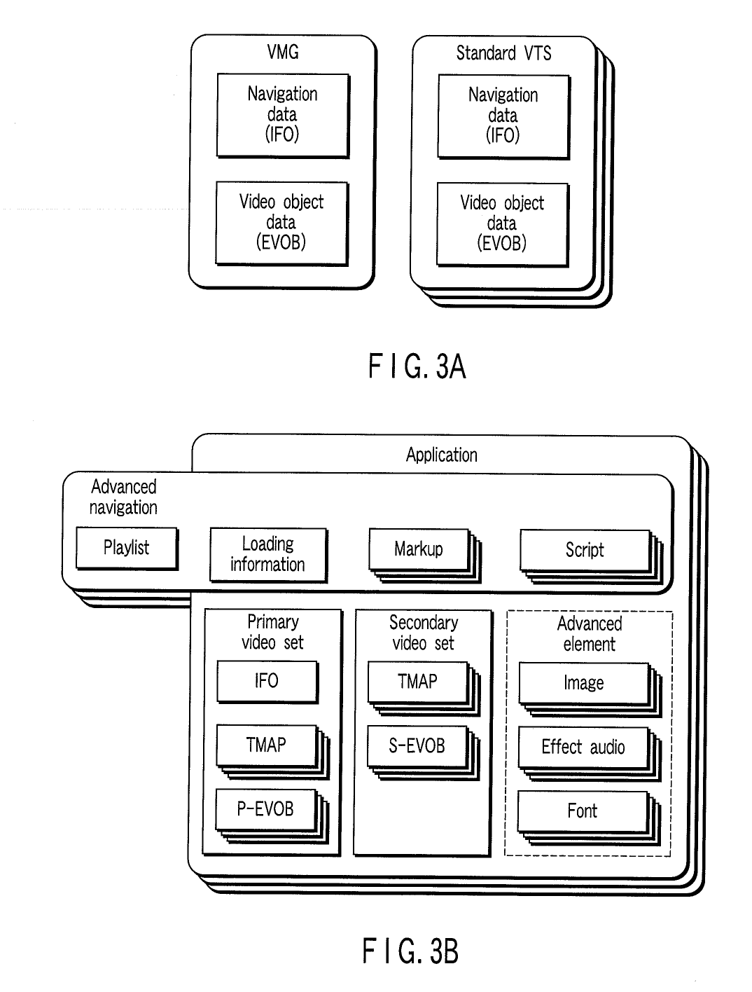

On the other hand, the advanced content is formed of advanced navigation data such as playlist, markup and script files, advanced data such as a Primary/Secondary Video Set, and an Advanced Element (such as an image, audio data and a text). Concerning the advanced content, it is necessary to position, on a disc, at least the Playlist file and Primary Video Set. However, the other data may be positioned on the disc or be acquired from a server.

<Standard Content (see FIG. 3A)>

The standard content is acquired by extending data defined by the version 1.1 DVD-video standard, and is, for example, high-resolution video data and high-quality audio data. Basically, the standard content is formed of a single VWG space and a single or a plurality of VTS spaces (called a “standard VTS” or simply “VTS”).

<Advanced Content (see FIG. 3B)>

The advanced content is acquired by extending the standard content, and used to realize higher interactivity. The advanced content is formed of files for Advanced Navigation, which include, for example, Playlist, Markup and Script, and is also formed of advanced data such as a Primary/Secondary Video Set, and an Advanced Element (such as an image, audio data and a text). The Advanced Navigation is used to manage the advanced data and advanced content.

When a playlist written in XML and advanced content are positioned on a disc, the player firstly executes the advanced content. The advanced content provides the following information:
Object mapping information: This is information included in each title and indicating presentation objects mapped on a title timeline;
Playback sequence: This is playback information for each title written in terms of a title timeline; and
Configuration information: This is system configuration information such as data buffer alignment.

In accordance with the Playlist, the first application (title) is executed referring to, for example, a Primary/Secondary Video Set, if there is any. One application is formed of Markup (including content/styling/timing information), Script and advanced data. The first Markup file, Script file and other resources, which form each application, are referred to in one manifest. Markup enables playing of advanced data, such as the Primary/Secondary Video Set, and the Advanced Element to be started.

<Disc Category>

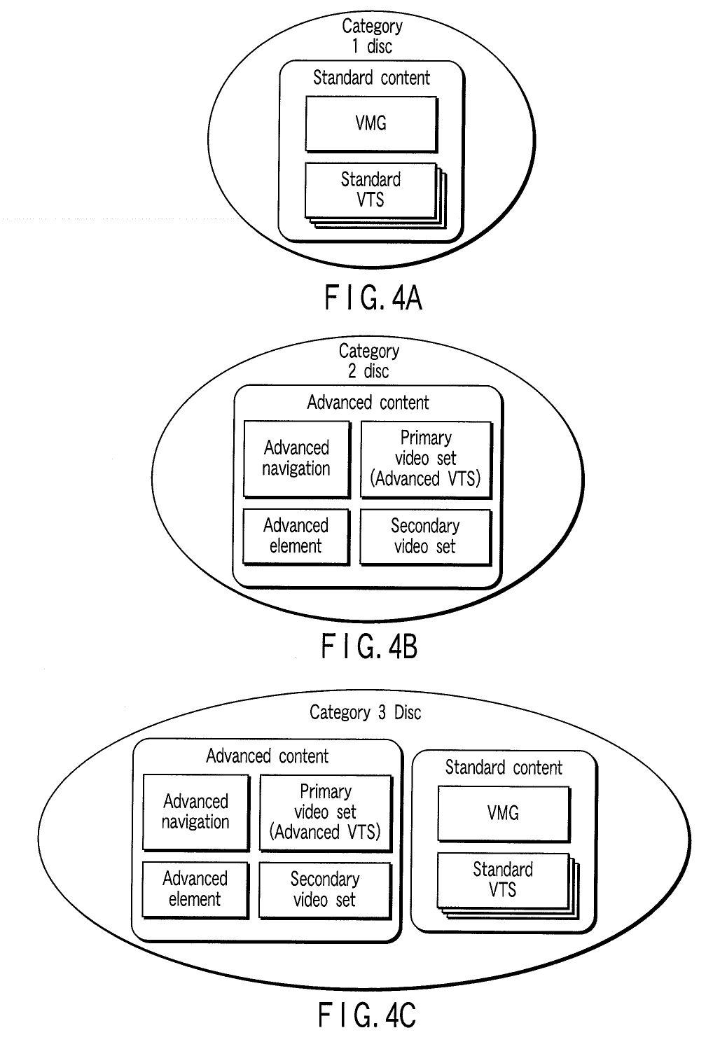

The standard employed in the embodiment defines the following three types of discs (disc of category 1; disc of category 2; disc of category 3):
Explanation of a disc of category 1 (concerning its configuration example, see FIG. 4A)

This disc contains only standard content formed of a single VMG and a single or a plurality of standard VTS. Namely, the disc does not contain advanced VTS or advanced content.
Explanation of a disc of category 2 (concerning its configuration example, see FIG. 4B)

This disc contains only advanced content formed of Advanced Navigation, Primary Video Set (advanced VTS), Secondary Video Set and Advanced Element. Namely, the disc does not contain standard content such as VMG or standard VTS.
Explanation of a disc of category 3 (concerning its configuration example, see FIG. 4C)

This disc contains advanced content formed of Advanced Navigation, Primary Video Set (advanced VTS), Secondary Video Set and Advanced Element, and standard content formed of VMG (video manager) and a single or a plurality of standard VTS. However, this VMG contains neither FP_DOM nor VMGM_DOM.

Although this disc contains the standard content, it basically follows the rules of the category-2 disc. Further, the state of the disc can be shifted from an advanced content playing state to a standard content reading state, and vice versa.

<Structure of Volume Space>

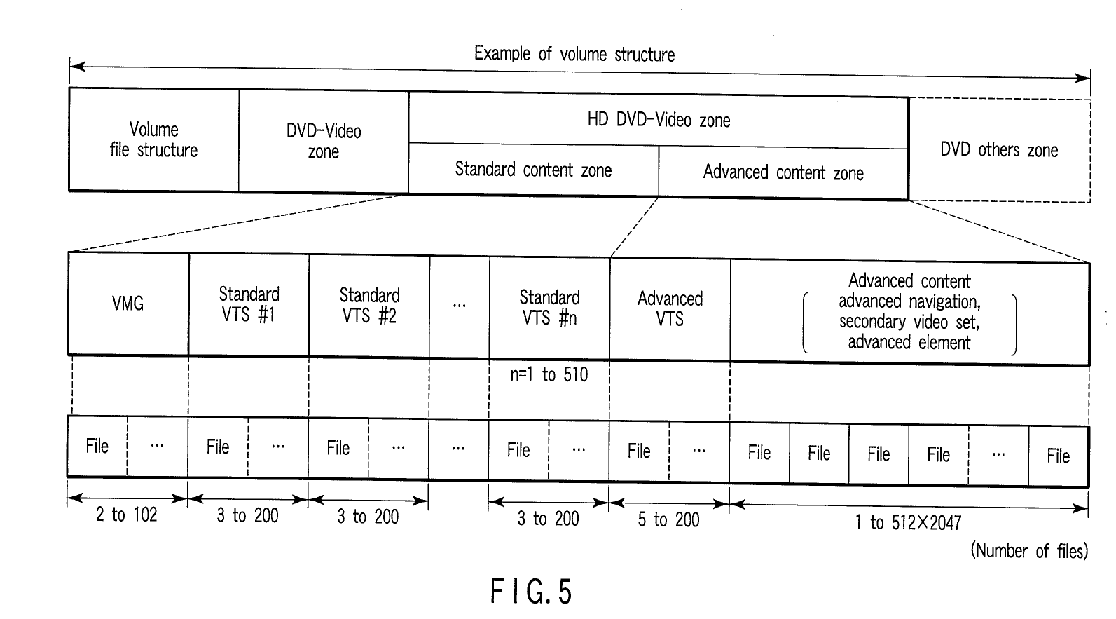

As shown in FIG. 5, the volume space of HD DVD video discs is formed of the following elements:

i) Volume and File structure: This is assigned to UDF structure.

ii) A single DVD-Video zone: This may be assigned to a data structure for DVD-Video format.

iii) A single HD DVD-Video zone: This may be assigned to a data structure for DVD-Video format, and is formed of a standard content zone and advanced content zone.

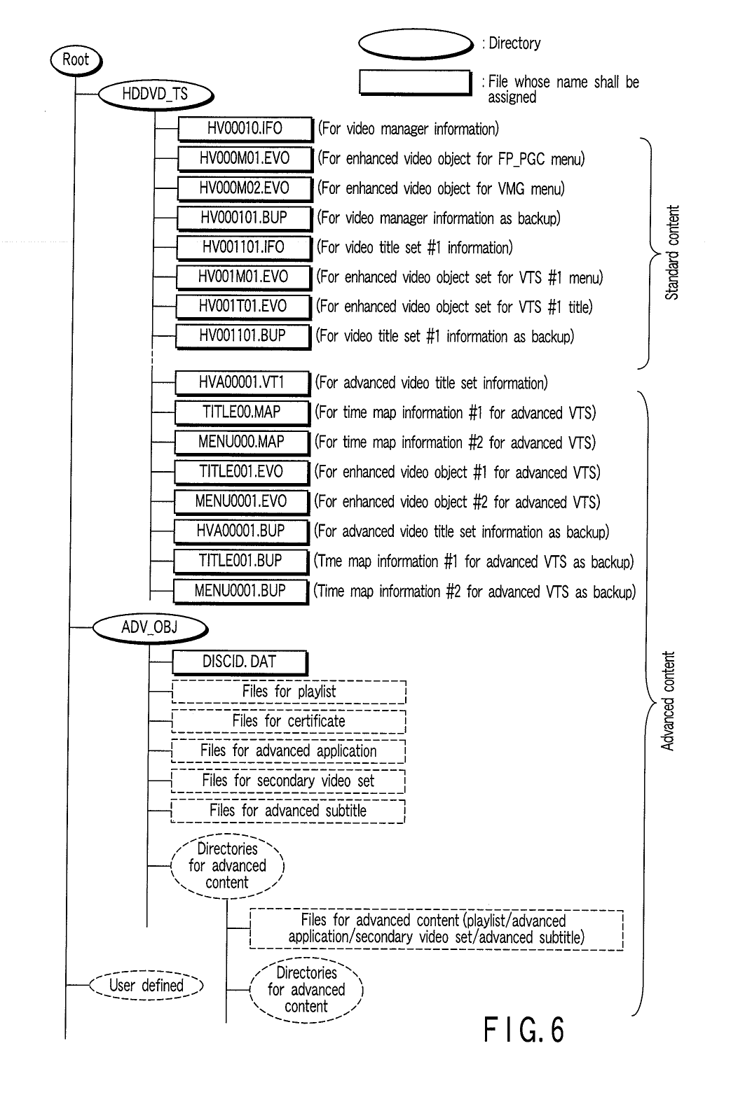

iv) DVD others zone: This may be used for applications other than DVD-Video and HD DVD-Video applications.

<Rules Concerning Directories and Files (FIG. 6)>

Requirements for files and directories related to HD DVD-Video discs will now be described. In FIG. 6, the data written in the boxes indicate file names.

HVDVD_TS Directory

“HVDVD_TS” directory is positioned just under the Root directory. All files related to a single VMG, a single or a plurality of standard video sets and a single advanced VTS (Primary Video Set) belong to this directory.

Video Manager (VMG)

Single video manager information item “HV00010.IFO,” enhanced video object for first play program chain menu (FP_PGCM_EVOB) “HV000EVO,” backup video manager information (VMGI_BUP) “HV000101.BUP,” and enhanced video object set for video manager menu (VMGM_EVOBS) “HV000M02.EVO,” which are constitutional files, belong to HVDVD_TS directory.

Standard Video Title Set (Standard VTS)

Video title set information (VTSI) “HV001101.1FO” and backup video title set information (VTSI_BUP) “HV001101.BUP,” which are constitutional files, belong to HVDVD_TS directory. Further, enhanced video object set for video title set menu (VTSM_EVOBS) “HV001M01.EVO” and enhanced video object set for title (VTSTT_VOBS) “HV001T91.EVO” are also constitutional files of HVDVD_TS directory.

Advanced Video Title Set (Advanced VTS)

Single video title set information item (VTSI) “HVA00001.VT1” and single backup video title set information item (VTSI_BUP) “HVA00001.BUP” can be recorded as constitutional files under HVDVD_TS directory.

Video title set time map information (VTS_TMAP) #1 (for title) and #2 (for menu) “TITLE00.MAP” and “MENU000.MAP”, and backup video title set time map information (VTS_TMAP_BUP) #1 and #2 “TITLE00.BUP” AND “MENU000.BUP” are formed of files belonging to HVDVD_TS directory.

Enhanced video object files #1 and #2 for enhanced video title set “TITLE00.EVO” and “MENU000.EVO” are also constitutional files under HVDVD_TS directory.

The file and directory names under HVDVD_TS directory are based on the following rules:

ADV_OBJ directory is positioned just under the root directory. All activation files for Advanced Navigation, Advanced Element and Secondary Video Set belong to this directory.

Just under ADV_OBJ directory, file “DISCID.DAT” unique to the advanced system is provided. This file is a disc discrimination data file.

All playlist files are provided just under ADV_OBJ directory. Any file for Advanced Navigation, Advanced Element and Secondary Video Set can be provided just under ADV_OBJ directory.

Playlist

Each playlist file can be provided just under ADV_OBJ directory with a file name of VPLIST %%%.XPL or APLIST %%%.XPL. “%%%” indicates a serial number ranging from “000” to “999” and assigned to each file. When a disc is loaded, the playlist file with the maximum number is processed firstly.

Directories for Advanced Content

The other directories for advanced content can be provided only under ADV_OBJ directory. Any file for Advanced Navigation, Advanced Element and Secondary Video Set can be provided under ADV_OBJ directory.

Files for Advanced Content

The number of files that can be provided under ADV_OBJ directory is limited to 512×2047, and the number of files that can be provided under each directory is limited to a value lower than 2048. Each file name is expressed by “d” or “d1” characters, and consists of a main body, period (“.”) and extension.

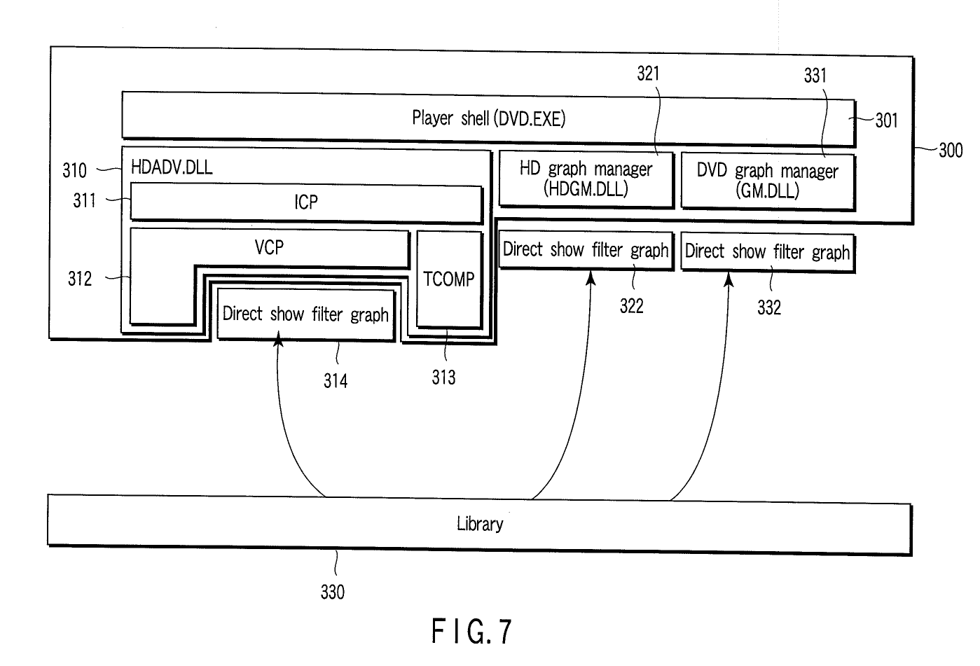

A description will now be given of player software for playing content recorded on an HD DVD. FIG. 7 shows the configuration of the player software.

As shown in FIG. 7, player software 300 comprises PlayerShell (DVD. EXE) 301, HDADV.DLL 310, HD Graph Manager (HDGM.DLL) 321, and DVD Graph Manager (GM.DLL) 331.

To play content, the player software 300 utilizes a technique called DirectShow that is executed under the environment of Windows™, an OS produced by Microsoft Corporation. DirectShow is a set of filters having various functions. To replay, for example, a moving picture, a filter graph is constructed by combining a plurality of filters selected from a filter library 340.

As described above, HD DVD content includes standard content and advanced content. For standard content and advanced content, different filter graphs must be constructed.

PlayerShell 301 identifies the type of each disc, then calls the Dynamic Link Library (DLL) corresponding to the identified type, and constructs a filter graph using the called DLL.

HDADV.DLL 310 constructs a filter graph 314 for playing advanced content for HD DVDS. HDADV.DLL 310 and filter graph 314 are means for playing advanced content. HD Graph Manager (HDGM.DLL) 321 constructs a filter graph 322 for playing standard content for HD DVDs. HD Graph Manager (HDGM.DLL) 321 and filter graph 322 are means for playing standard content. DVD Graph Manager (GM.DLL) 331 constructs a filter graph 332 for replaying DVDs.

HDADV.DLL 310 is formed of a plurality of modules including a module for constructing a graph manager for reading advanced content. HDADV.DLL 310 includes ICP 311, VPC 312 and TCOMP 313. ICP 311 reads Playlist written in XML and performs scheduling of time of reading data from an optical disc, and scheduling of times of executing various application programs. In accordance with the scheduling, ICP 311 instructs VPC 312 to read data from the optical disc and execute application programs, and also instructs TCOMP 313 to perform image rendering in accordance with image data written in XML. VPC 312 constructs a filter graph for playing advanced content for HD DVDs.

A description will be given of filter graphs for playing standard content and advanced content.

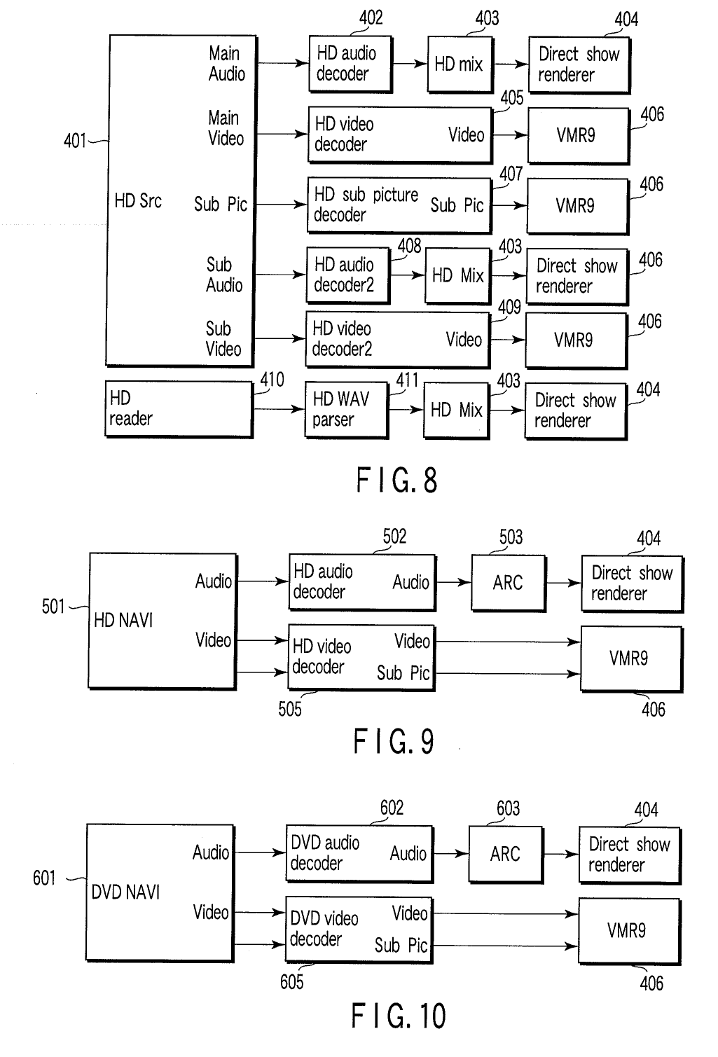

FIG. 8 shows the configuration of a filter graph for playing advanced content. As shown in FIG. 8, the filter graph comprises an HD Src 401, HD Audio Decoder 402, HD Mix 403, HD Video Decoder 405, HD SubPicture Decoder 407, HD Audio Decoder2 408, HD Video Decoder2 409, HD Reader 410, HD WAV Parser 411, HD Mix DirectShow Renderer 404 and VMR9 406.

The HD Src 401 separates, from data reproduce by an optical disc drive, main video data, main audio data, sub audio data and sub picture data. The HD Video Decoder 405 extends the main video data separated by the HD Src 401 to form non-compressed main video data, and sends the resultant data to the VMR9 406. The HD SubPicture Decoder 407 extends the sub picture data separated by the HD Src 401 to form non-compressed sub picture data, and sends the resultant data to the VMR9 406. The HD Video Decoder2 409 extends the sub video data separated by the HD Src 401 to form non-compressed sub video data, and sends the resultant data to the VMR9 406. The VMR9 406 mixes the supplied main video data, sub video data and sub picture data and sends the resultant data to the GPU 105.

The HD Audio Decoder 402 extends the main audio data separated by the HD Src 401 to form non-compressed main audio data, and sends the resultant data to the HD Mix 403.

The HD Reader 410 analyses data reproduced by the optical disc drive to determine whether WAV data is contained, and sends the determination result to the HD WAV Parser 411. If WAV data is contained, the HD WAV Parser 411 extracts the WAV data and sends it to the HD Mix 403.

The HD Mix 403 mixes the supplied main audio data, sub audio data and WAV data, and sends the mixed data to the HD Mix DirectShow Renderer 404. The HD Mix DirectShow Renderer 404 sends the mixed data to the sound controller 106. The sound controller 106 generates an analog audio signal from the supplied data, and outputs it to the speaker 19.

Referring then to FIG. 9, the filter graph 322 for playing standard content will be described. As shown in FIG. 9, the filter graph 322 comprises an HD Navi 501, HD Audio Decoder 502, ARC (Audio Rate Converter) 503, DirectShow Renderer 404, HD Video Decoder 505 and VMR9 (Video Mixing Renderer 9) 406. The HD Navi 501 separates, from data reproduced by an optical disc drive, video data, audio data, and sub picture data. The HD Video Decoder 505 extends the video data and sub picture data to form non-compressed data, and sends the resultant data to the VMR9 406. The VMR9 406 has, for example, a function of mixing video data and sub picture data, and a function of displaying subtitles, and sends the mixed video data to the GPU 105.

The HD Audio Decoder 502 extends the audio data to form non-compressed data, and sends the resultant data to the ARC 503. The ARC 503 converts the non-compressed data into data of an appropriate sampling rate, and sends it to the DirectShow Renderer 404. The DirectShow Renderer 404 supplies the data to the sound controller 106. The sound controller 106 generates an analog audio signal from the supplied data, and outputs it to the speaker 19.

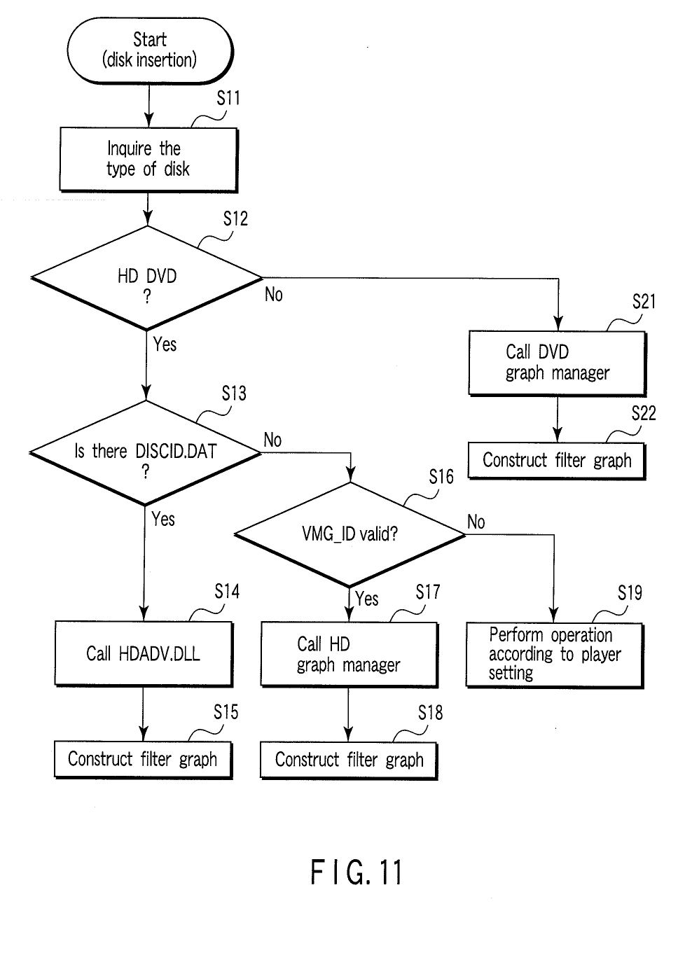

The filter graph 332 for replaying a DVD will be described. FIG. 10 shows the configuration of a filter graph for playing standard content. As shown in FIG. 10, the filter graph 332 comprises an HD Navi 601, HD Audio Decoder 602, ARC (Audio Rate Converter) 603, DirectShow Renderer 404, HD Video Decoder 605 and VMR9 (Video Mixing Renderer 9) 406. The HD Navi 601 separates, from data reproduced by an optical disc drive, video data, audio data, and sub picture data. The HD Video Decoder 605 extends the video data and sub picture data to form non-compressed data, and sends the resultant data to the VMR9 406. The VMR9 406 has, for example, a function of mixing video data and sub picture data, and a function of displaying subtitles, and sends the mixed video data to the GPU 105.

The HD Audio Decoder 602 extends the audio data to form non-compressed data, and sends the resultant data to the ARC 603. The ARC 603 converts the non-compressed data into data of an appropriate sampling rate, and sends it to the DirectShow Renderer 404. The DirectShow Renderer 404 supplies the data to the sound controller 106. The sound controller 106 generates an analog audio signal from the supplied data, and outputs it to the speaker 19.

A description will now be given of a process performed using the above-described player software for playing content from an HD DVD/DVD. As described above, the PlayerShell 301 calls one of the DLLs 310, 321 and 33 that corresponds to the type of a disc inserted in the ODD 112. Referring to the flowchart of FIG. 11, the procedure of the player software 300 identifying the type of a disc inserted in the ODD 112 and calling a DLL according to the type of the disc will be described.

When a disc is inserted, the PlayerShell 301 inquires of the OS the type of the disc inserted in the disc (step S11). Upon receiving data indicating the type of the disc, the PlayerShell 301 determines whether the inserted disc is an HD DVD (step S12). If it is determined that it is an HD DVD (Yes at step S12), the PlayerShell 301 firstly confirms the existence of file “DISCID.DAT” under ADV_OBJ directory in the management information region (step S13). File “DISCID.DAT” is unique to recording mediums that can record advanced content. Upon confirming “DISCID.DAT” (Yes at step S13), the PlayerShell 301 calls HDADV.DLL 310 to play a filter graph for playing advanced content (step S14).

The VCP 312 of the HDADV.DLL 310 selects, from the filter library 340, the HD Src 401, HD Audio Decoder 402, HD Mix 403, HD Video Decoder 405, HD SubPicture Decoder 407, HD Audio Decoder2 408, HD Video Decoder2 409, HD Reader 410, HD WAV Parser 411, HD Mix DirectShow Renderer 404 and VMR9 406, thereby constructing the filter graph 314 (step S15). After that, using the constructed filter graph, the VCP 312 starts to play advanced content. Namely, the VCP 312 starts to read “playlist.xml(Tentative)” of ADV_OBJ directory under the root directory.

If file “DISCID.DAT” is not confirmed (No at step S13), the PlayerShell 301 confirms whether “VMG_ID” is valid (step S16). Whether “VMG_ID” is valid is confirmed as follows. If the disc is of category 1, “VMG_ID” is “HVDVD-VMG100.” Further, bit 0-3 of VMG_CAT as a category specifying area indicates “No Advanced VTS exists.”

If “VMG_ID” is valid, the PlayerShell 301 calls the HD Graph Manager (HDGM.DLL) 321 (step S17). The called HD Graph Manager (HDGM.DLL) 321 selects, from the filter library 340, the HD Navi 501, HD Audio Decoder 502, ARC (Audio Rate Converter) 503, DirectShow Renderer 404, HD Video Decoder 505 and VMR9 (Video Mixing Renderer 9) 406, thereby constructing the filter graph 322 (step S18). The filter graphs 321 and 322 start to play standard content.

If it is further determined that the disc does not belong to any type of HD DVD, the PlayerShell 301 performs an operation according to the setting (step S19).

If it is determined at step S12 that the disc is not a HD DVD (i.e., a DVD is inserted in the ODD 112) (No at step S12), the PlayerShell 301 calls the DVD Graph Manager 331 (step S20). The DVD Graph Manager 331 selects, from the filter library 340, the HD Navi 601, HD Audio Decoder 602, ARC (Audio Rate Converter) 603, DirectShow Renderer 404, HD Video Decoder 605 and VMR9 (Video Mixing Renderer 9) 406, thereby constructing a filter graph for replaying a DVD (step S21). The DVD Graph Manager 331 and filter graph 332 start to play standard content.

As described above, in the embodiment, determination as to the type of content recorded on an HD DVD is executed based on whether file “DISCID.DAT” unique to advanced content exists. Therefore, the determination can be easily executed. Accordingly, the DLL necessary for replaying the HD DVD can be called quickly to perform the replay.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an optical disc apparatus configured to reproduce data from an optical disc with at least one of a first type content and a second type content recorded thereon;
a first content playback unit configured to play the first type content;
a second content playback unit configured to read a playlist indicating a procedure for playback of the second type content, and configured to play the second type content; and
a judgment/playback unit configured to determine whether the optical disc stores a file unique to the second type content, the judgment/playback unit configured to induce the first content playback unit to play the first content when it is determined that the file is not stored, and configured to induce the second content playback unit to play the second content when it is determined that the file is stored.

2. The information processing apparatus according to claim 1, wherein the file is a disc identifying data file provided under a directory of the optical disc.

3. An information processing apparatus comprising:
an optical disc apparatus configured to reproduce data from an optical disc at least one of a first type content and a second type content recorded thereon;
a filter library comprising a plurality of filters;
a first filter manager configured to select a first filter of the filter library to construct a first filter graph for playing the first type content;
a second filter manager configured to select a second filter of the filter library to construct a second filter graph for playing the second type content;
a disc-type judgment unit configured to determine whether the optical disc stores a file unique to the second type content; and
a library call unit configured to induce the first filter manager to construct the first filter graph when it is determined that the file is not stored, and configured to induce the second filter manager to construct the second filter graph when it is determined that the file is stored.

4. The information processing apparatus according to claim 3, wherein the file is a disc identifying data file provided under a directory of the optical disc.

5. A reading method for use in an information processing apparatus which includes an optical disc apparatus for reading data from an optical disc provided with at least one of a first type content and a second type content recorded thereon, comprising:
determining whether the optical disc stores a file unique to the second type content;
causing a first content playback unit to play the first type content when it is determined that the file is not stored; and
causing the second content playback unit to read a playlist indicating a procedure for playback of the second type content, and causing the second content playback unit to play the second type content when it is determined that the file is stored.

6. The method according to claim 5, wherein the file is a disc identifying data file provided under a directory of the optical disc.
